(19) United States
(12) Patent Application Publication
(10) Pub. No.: US 2026/0064099 A1
(43) Pub. Date: Mar. 5, 2026

(54) CUSTOMIZABLE PROGRAMMING CONFIGURATION

(71) Applicant: Universal Robots A/S, Odense S (DK)

(72) Inventor: Anders Kromann Nielsen, Odense (DK)

(73) Assignee: Universal Robots A/S, Odense S (DK)

(21) Appl. No.: 19/103,167

(22) PCT Filed: Sep. 12, 2023
(86) PCT No.: PCT/DK2023/050221

§ 371 Date: Feb. 11, 2025

(30) Foreign Application Priority Data
Sep. 12, 2022 (DK) PA202270439

(51) Int. Cl. G05B 19/409; B25J 9/16; G06F 3/04842

(52) U.S. Cl. CPC G05B 19/409; B25J 9/1656; G06F 3/04842; G05B 2219/35433; G05B 2219/36137; G05B 2219/36542; G05B 2219/39438

(57) ABSTRACT

The invention relates to a robot user interface configured for presenting a control program to a programmer, the control program being displayable to the programmer via a program view of said user interface. The control program controls operations of a robot, wherein at least some parts of the control of said robot is defined via an 5 argument of one or more operation parameter. The user interface is further configured to present a part of said one or more operation parameters to an operator of said robot via an operator view of said user interface. The operator view is configured for displaying arguments of said one or more operation parameters, and the operator view is configured for allowing said operator to change said argument of said part of said 10 one or more operation parameters. Further the invention relates to a method of configuring the robot control program using the user interface.

### FIELD OF THE INVENTION

The invention relates to a robot user interface facilitating operation parameter configuration by a robot operator and a method of configuring such operation parameters.

### BACKGROUND OF THE INVENTION

Today robots are often chosen to automatise otherwise manual work. Many deployed robot applications are chosen because a robot is easy to adapt to several different tasks. However, in the art such adaption face bottlenecks in that a robot programmer must configure the robot even to minor changes in the robot control program. A robot programmer is necessary to ensure that such configuration does not compromise safety or robot constrains. However especially in small and medium size enterprises a robot programmer may not always be available and thus, the flexibility of the robot and the possibility to adapt the robot to several tasks are linked closely to the availability of and cost associated with the robot programmer. US2013096719 is an example of how configuration of a robotic system, via an interface, depends on the expertise of the user. As an example, a robot programmer (high experienced user) is allowed to change more parameters than a less skilled person to ensure safe configuration of the robot system.

This problem is solved in that art by the use of input dialog boxes which are automatically presented to the robot operator at predetermined states of the robot control program. Hence, e.g. at every start-up or every time the program enters a given function, the robot operator is prompted to provide one specific input. This way of configuring a robot control program is however brittle and has some strict limitations on what can be configured.

### SUMMARY OF THE INVENTION

The inventors have identified the above-mentioned problems and challenges related to configuration of a robot and solved these problems by the present invention as described below. By the present invention, a person having no particular skills in robot programming is allowed to change e.g. a robot cycle such as a cycle of a robot arm including waypoints and only parameters such as speed of movement of the robot arm.

In an aspect, the invention relates to a robot user interface configured for presenting a robot control program to a robot programmer, the robot control program being displayable to the robot programmer via a program view of the user interface. The robot control program comprises a robot control sequence based on which operations of a robot is controllable, wherein at least some parts of the control of the robot is defined via an argument of one or more operation parameters. The user interface is further configured to present a part of the one or more operation parameters to an operator of the robot via an operator view of the user interface. The operator view is configured for displaying arguments of the part of the one or more operation parameters, and the operator view is configured for allowing the operator to change the argument of the part of the one or more operation parameters.

This is advantageous in, that in this way it is possible to only allow an operator, which typically does not have much programming experience, to access the operator view and thereby only configure the argument of the relevant operation parameters. Accordingly, the operator cannot mess up any of the robot control program and thereby the operator cannot mess up the operation of the robot. This is because it would typically be an experienced programmer that has selected the part of the operation parameters and thereby the associated arguments which is accessible and configurable by the operator via the operator window.

Further, separating the possibility of configuration of operation parameter arguments of a robot control program from the execution of the robot control program is advantageous in that it can be ensured that only persons skilled in robot programming have access to the robot control program. This is true while at the same time maintaining the possibility, for persons with no or limited skills in robot programming, to perform various specific configurations of the operation of the robot. Such tasks could e.g. include change speed or acceleration, define one of two predefined trajectories or poses, change distance between fingers of a gripper when opening and closing, call functions of the robot control program, etc.

Further, by separating operation parameters configurable by the operator from remaining operation parameters according to the present invention is advantageous in that the robot programmer in this way get a better overview of the operation parameters configurable by the operator.

The robot is controlled by a robot controller comprising a processor and a memory. Based on input from internal robot sensors such as position encoders, force and torque sensors and if relevant external sensors such as sensors related to tool or peripheral devices. The controller controls electric power to motors and thus controlling movement of the robot. The controller can be provided as an external device or as a device integrated into the robot or as a combination thereof. The controller is communicating with a user interface enabling a user to control, configure and/or program the robot.

The user interface may be a teach pendent which can communicate with the controller via wired or wireless communication protocols. Alternatively, the robot interface may be part of a cloud service or cloud computer, a computer or simulation program hereof, etc.

The user interface comprises a display and may be equipped with a touch screen and input devices such as buttons. The display can be configured to display one view at the time or to share the display area between two or more simultaneous views.

The robot control program (also sometimes simply referred to as program) should be understood as a sequence of robot operations. The sequence of robot operations can for instance be provided as a program tree including operation parameters, functions, etc. needed to control the movement of the robot and handling of object/tool as required in the robot cell. The robot control program may be structured in a program tree or in program blocks which control the robot based on input from various internal or external sensors. The robot control program is visible in the program view of the user interface where it also may be developed or amended by a robot programmer such as an integrator. It is noted that a robot programmer can be any person that is cable of programming the robot and may also be referred to as programmer, robot integrator or integrator.

An argument should be understood as a value of an operation parameter, a function call, a string, a Boolean operator, etc. Taking the name of a function of the robot control program as example, this name represents a value. If this function is required, the value representing the function name can be used in a function call. Such function call is a typical part of the robot control program. The arguments may be stored in the program or in the data storage associated with the operator view. Accordingly, an operation parameter may be a waypoint, value (related to speed, acceleration, etc) function call, etc.

The program view should be understood as a view presented to the user via which the robot control program can be viewed, and optionally also a view where the robot control program can be defined, written and/or amended.

In one embodiment the program view should be understood as a view on the user interface where a robot programmer is able to view, define, write and/or amend a robot control program. Alternative, a program can be downloaded and followed in the program view as it is being executed. Further, a robot programmer is able to add, delete and change in the program from the program view. The access to this functionality of the program view can however be restricted/limited (e.g. protected by a password) to ensure that only intended users of the robot, such as skilled robot programmers, have editing rights of the robot control program, such as rights to define, write and/or amend a robot control program.

The operator view should be understood as a view of the user interface where a robot operator is able to configure the program by changing arguments of the operation parameters available in the operator view. The operation parameters that is available in the operator view is defined by the robot programmer and thus the robot programmer has evaluated as safe and relevant for an operator of the robot to be able to configure.

In the context of the present invention, the robot control program should be understood as not possible to configure from the operator view. In other words, the robot control program cannot be defined, written and/or amended via the operator view, except for the allowed changes of the operational parameter(s) available in the operator view.

A user should be understood as a person either programming the robot or responsible for the robot while the robot is in operation. Thus, a user may e.g. be a robot integrator, programmer or an operator. The latter, which typically is not a trained robot programmer, only have access to the part of the robot control program that is made available by the robot programmer/integrator in the operator view. A skilled robot programmer is also simply referred to as a programmer in this document whereas the person handling or monitoring the robot while it is in operation is referred to as an operator.

In an exemplary embodiment of the invention, the user interface further comprises a configuration view.

The configuration view is advantageous in that via this view a programmer is able to define which parts of the robot control program an operator should be able to access via the operator view. Hence, the configuration view is a closed environment only for programmers. In an exemplary embodiment of the invention, operation parameters of the robot control program are selectable from the configuration view.

In an exemplary embodiment of the invention, the arguments of the part of the one or more operation parameters displayed at the operation view are configurable via said configuration view.

In this way, at least part of what is displayed to the operator in the operator view is configured in the configuration view e.g. by the operator.

In an exemplary embodiment of the invention, operation parameters of the robot control program is selectable from the configuration view.

In the configuration view, all relevant operation parameters associated with the robot control program may be selectable which make it easy for the programmer to select the relevant part of operation parameters and thereby make them and their arguments available in the operator view. This decision may be made e.g. by the robot programmer.

In an exemplary embodiment of the invention, the configuration view is comprised by the program view.

The configuration view may be a separate view or part of the program view. When part of the program view the programmer can easily switch between selecting operation parameters for the operator view and writing or amending the robot control program

In an exemplary embodiment of the invention, the part of the one or more operation parameters of the robot control program is selectable from the robot control program.

Selecting operation parameters from the robot control program is advantageous in that then the programmer is able to select the relevant part of the operation parameters directly from the robot control program. In an embodiment, the programmer is able to select operation parameters as they are created in the development of the robot control program. Hence, either during development or after development of the control program, the operation parameters which are allowed to change may be selectable. When selected, they are made available for the integrator who then may determine to make them available to the operator. Alternatively, the developer is making a subset of operation parameters available to the operator directly via the user interface e.g. via the operator view and another subset disposal to the integrator who then may make them available to the operator via the user interface e.g via the operator and/or configuration views. Hence, the value (attribute) of an operation parameter or the operation parameter itself may be selectable/adjustable directly in the robot control program via the operator view. This is possible in a safe manner in that the programmer and/or integrator has defined which operation parameters and which values hereof that are safe for the operator to adjust without compromising safety of the operation of the robot and its environment.

In an exemplary embodiment of the invention, the user interface comprises a display presenting selectable views to a user wherein the selectable views include at least the program view, the configuration view and the operator view.

The views available on the user interface are typically selectable one by one but may also be available side by side so that two views can be presented simultaneously on the user interface.

The user interface may comprises a touch display presenting to the operator at least one from the list comprising configurable operation parameter, selectable functions and status of configurable parameters. The presented information may be presented in the form of a drop-down menu and/or as a list of information. This is advantageous in that it has the effect, that the operator has an easy overview of and access to the configurable parts that is configurable.

In an exemplary embodiment of the invention, the user interface is configured for displaying status of at least part of the one or more operation parameters while the robot control program is executed.

Being able to read the status of various operation parameters while the robot is running i.e. in real-time as the robot is controlled by a robot controller to move according to the program sequence is advantageous in that it becomes easier to estimate or determine a new value for an operation parameter if the current value is available for comparison. This is useful for an inexperienced robot programmer. The status may be displayed in the operator view.

In an exemplary embodiment of the invention, the operator view is configured for displaying at least one selection parameter, and the operator view is configured for allowing the operator to set at least one selection parameter. The operator view is configured for displaying arguments of the one or more operation parameters based on the user's selection of the at least one selection parameter.

This is advantageous in that the operational parameters displayed at the configuration view dynamically can be changed based on the user's selection of the selection parameters. Consequently, a user can for instance via one or more selection parameters select a certain operation, task or part of the robot program that need to be modified, and the operational view will based on the selection automatically be configured to display the relevant operational parameters for the desired changes. For instance, if the operator need to change infeed parameters such as size and shape of objects to be picked up by the robot arm during a robot program, that user may select a selection parameter, which in this example may be labelled infeed parameter or simply infeed, which upon selection causes the operational view to display operational parameters relating to the infeed of objects such as the size and shape of the object, such as a length parameter, a width parameter, a height parameter, a weight parameter, force with which the tool, in case of a gripper, may apply to the object, etc.

The operator view may be associated with a data storage. Associated should be understood as indirectly or directly communicating between the operator view of the user interface and thus the values provided by the operator and the data store where such values are stored with a reference to the operation value of which it is associated with.

The operator view may be configured for retrieving previous parameter values from the data storage. Being able to store input provided by the operator via the operator view is advantageous in that it has the effect, that the operator does not need to specify a certain value each time the robot program is initiated. Further, it allows the operator to load previous lists of parameter values so that if an object is to be used in the future or was used in the part only a specific data set is to be loaded to handle this new object.

In an exemplary embodiment of the invention, the content displayed in the operator view is configurable.

The robot programmer developing the program sequence determines the content of the operator view based on assumption/knowledge of what is relevant for an operator to be able to configure. If over time it turns out that other not visible parameters are required visible and/configurable on the operator view, the robot programmer is able to facilitate this.

In an exemplary embodiment of the invention, the operator view is available to the operator and/or to the programmer prior to operation mode of the robot is initiated.

The relevance of the operator view is high when the robot is not in the operation mode, for instance when an operator is reconfiguring the operation of the robot prior to starting the operation mode, where the robot performs the operations defined by the robot control program. During the operation mode, instead a status view of the arguments of the operation parameters may be visible in the user interface.

It should be noted that operator/programmer may select the operator view on user interface by pressing buttons/icons of a menu presented in the display of the user interface.

In an exemplary embodiment of the invention, the part of the one or more operation parameters are configurable from both the program view and from the operator view.

Being able to configure parameters both from the program view and from the operator view is advantageous in that the skilled robot programmer have access to all parameters from the program view whereas the less skilled user only has access to part of the parameters from the operator view. Hence, the invention essentially ‘lifts’ parts of the program configuration, such as part dimensions, speed, acceleration, etc. out of the complex program view/environment and into the simpler operator view thereby allowing operators to simply adapt a robot control program.

In an exemplary embodiment of the invention, access to the program view is restricted.

Restricting access to the program view is advantageous in that it protects the operator from enter the robot control program by mistake and risk adjusting the program sequence. The restriction may e.g. be implemented by use of password and username The part of the one or more operation parameters may be predetermined. The relevant operation parameters may be predetermined in that often when looking at the robot cell and the objects to be handled by the robot, the skilled programmer would know which operation parameters that could be relevant for an operator to be able to configure i.e. change argument of.

The user interface/robot control system of any of the paragraphs [0005] to implementing the method of the paragraphs [0049] to [0096].

An aspect of the invention relates to a method of configuring a robot control program of a robot, the method comprises the steps of:-by a robot programmer develop the robot control program to facilitate control of the robot in a predetermined operation cycle, wherein the control of the robot in the predetermined operation cycle is based on a plurality of operation parameters,-presenting to the robot programmer the robot control program in a program view of a user interface,-the robot programmer is selecting a part of the plurality of operation parameters and making the selected part of the plurality of operation parameters available to an operator in an operator view of the user interface,-the operator is configuring the robot control program by changing an argument of at least one of the part of the plurality of operation parameters via the operator view, and thereby change operation of the robot from being controlled in the predetermined operation cycle to be controlled in a modified operation cycle.

Being able to change parts of the robot control program via a user interface comprising an operator view dedicated to this particular configuration is advantageous in that it has the effect, that the person configuring the program does not need to be trained in programming. Hence almost any persons can do the configuration without risking to unintentional damaging the robot control program. Thus, there is no need for a programmer or robot integrator to perform such configuration. Accordingly, change between two operation cycles can be made fast by persons usually operating the robot leading to a better exploitation of the robot e.g. in a tending application where objects of varying size are handled.

Defining a plurality of configurable operation parameters accessible without accessing the robot control program is advantageous in that it has the effect, that the operator is able to perform various configurations of the operation of the robot without specialised knowledge of robot programming. Further, configuration of the operation of the robot can be made without access to the robot control program.

Being able to change an argument of an operation parameter is advantageous for the operator e.g. when change object size or type in e.g. a tending application. In a simple application it may only be the outer dimensions of an object that need to be updated to be able to continue the tending application with a new object.

The method of the present invention is advantageous in that in contrary to prior art system e.g. using program initiated pop-up boxes to provide values to operation parameters, the arguments provided by the current method is stored in the program or on an external data storage. Thus, if the program is paused/stopped, when resumed/started again the arguments are still available to the robot control program. There will be no pop-up box querying values from the user each time a specific part of the robot control program is executed.

The robot should be understood as a robot arm comprising a plurality of robot joints connecting a robot base and a robot tool flange, where some of the robot joints may be connected by robot links, for instance a robot arm comprising six joints or similar type of robot arm.

The robot control program should be understood as comprising basic control features or commands that are typically developed by the robot original equipment manufacturer. As a non-limiting example of such basic control features could be mentioned the Move command. By using such features, a robot integrator only needs to specify two waypoints and the desired type of Move command for moving the robot from one pose in the first waypoint to another pose in the second waypoint. A variety of Move commands exists which when used control movement of the robot different such as with reference to the so-called joint space or linear movement of the tool center point between the two waypoints just to mention two.

The program tree, sequence or block are all referring to the actual software code comprised by the robot control program i.e. the robot control program controlling the robot in an operation cycle in a particular application. A non-limiting example of such application could be the control of a robot picking up an object in a position, moving along a specific path to another position where it is positioning the object before returning to the first position to pick-up a new object. Such robot control program is typically developed by a robot integrator by using the basic control features mentioned above in combination with input from various sensors/external input signals.

Part of the robot control program is according to the present invention configurable via an operator view of a user interface. Hence as a consequence of such configuration, the robot is subsequently controlled in a modified operation cycle. The configuration should be understood to include as least an amended of one or more operation parameters of the robot control program. The configurable part may be defined e.g. by a robot integrator developing the robot control program. During or after the development of the robot control program the robot programmer enables one or more operation parameters to be configured in the operator view. Thus, any person having access to the operator view thereby has the opportunity to change the argument of operation parameters available in the operator view.

An operation cycle should be understood as a number of operations performed by the robot, such as movements of the robot and/or its associated robot tool for it to perform a desired task. The operation cycle is typically defined by the robot control program used by the robot controller to control the robot when the robot integrator has integrated the robot e.g. in a robot cell.

A modified operation cycle according to an embodiment should be understood as an operation cycle comprising an operation parameter the argument of which has been modified. Hence, a modification could be the change of an argument of an operation parameter such as the distance between fingers of a gripper handing an object, positions the object is to be moved from/to, a function call, etc.

In an exemplary embodiment of the invention, the part of the operation parameters available in the operator view is selected in a configuration view of the user interface.

The configuration view is advantageous in that it has the effect, that operation parameters of the robot control program is visible to the robot programmer and thus, it is easy for the robot programmer to select the relevant operation parameters to make available in the operator view.

In an exemplary embodiment the configurator view is only available prior to running the robot control program In an exemplary embodiment of the invention, limits of the arguments of the part of the operation parameter are configured in the configuration view.

Being able to limit or restrict the input which is possible to make via the operator view is advantageous in that it has the effect, that the operator only is allowed to provide valid arguments. A limit could be an upper limit such as a maximum value, a lower limit such as a minimum value, a range such as a maximum and a minimum value, a time period, etc.

In an exemplary embodiment of the invention, operation parameter options are defined in the configuration view.

Operation parameter options should be understood as rules, limits, etc. associated with one or more operation parameters. Hence, the configuration view is advantageous in that rules associated with a particular operation parameter can easily be applied. Such rules may include top level programming such as if/else loops, comparison of argument of operation parameters, etc.

In an exemplary embodiment of the invention, the configuration view is included in the program view.

A configuration view included in a program view may not be as user friendly as a stand-alone configuration view. However, an integrated configuration view may be faster to use by a trained robot programmer in that operation parameters can be made as the operation parameter is created.

In an exemplary embodiment of the invention, a before start routine is executed once before start of execution the robot control program is configured.

A before start routine is advantageous in that before start of robot operation, configuration and initiation of various routines, parameters and in/output, etc. can be ensured to have default/start values. Preferably, the before start routine is configured in the configuration view.

In an exemplary embodiment of the invention, a status task returning information of the robot control program is configured.

A status task is advantageous in that it has the effect, that the operator can set up various monitoring tasks of the program execution. In this way the operator collects or retrieves information from the program as the program is running/executed. Preferably, the status tasks are configured in the configuration view.

In an exemplary embodiment of the invention, at least one of the plurality of operation parameters is a function call.

The operation parameter may be a function call and by changing the argument of such function call may lead to a modified operation cycle. Being able to call a new function e.g. in dependency of the size of a variable (e.g. variable<X) is advantageous for the operator. This is true e.g. if objects having a particular geometry have to be sorted different than the rest then different functions may be called and executed e.g. in dependency of input from a sensors or only executed if a specific condition is fulfilled, etc. Hence, a particular sorting operation cycle may be called and executed by the robot controller. Alternatively, if a feeding conveyor are supplying objects to the robot from two sides, then the operator may easily shift between “left” and a “right” pick-up function and thereby modify the operation cycle.

It should be noted that the operator may have access to change as many configurable parts as is made available by the robot programmer.

In an exemplary embodiment of the invention, the argument is changed within a predetermined range.

Specifying a specific range in which the operator is allowed to change an argument of an operation parameter is advantageous in that it has the effect, that arguments outside this range is rejected and thus the operator cannot type in any argument that compromises safety or functionality of the robot. Such range is typically predetermined and determined by the robot programmer e.g. when enabling an operation parameter to be available in the operator view.

In an exemplary embodiment of the invention, the argument is associated with a robot tool or peripheral device.

Being able to change the argument of an operation parameter that control or indirectly controls a robot tool or peripheral device is advantageous in that it has the effect, that not only is the operator able to control the actual robot but also devices that are interacting with the robot such as third party parts and software. Thereby flexibility or agility of the robot is increased without the need of a skilled robot integrator or the like.

In an exemplary embodiment of the invention, the at least one operation parameter is selected by a robot programmer prior to commissioning the robot to operation.

The robot programmer is typically a robot integrator who is defining in the robot control program which parts should be available for the operator to configure. By letting a trained robot programmer define such parts it is ensured that all requirements related to safety is complied with independent on how the operator is configuring such part such as e.g. arguments of operation parameters.

A robot is commissioned when the robot integrated is finish with programming and testing of the robot. Hence, e.g. when the robot is safety approved, the robot could be the to be commissioned.

In an exemplary embodiment of the invention, the at least one operation parameter is automatically available for presentation in the operator view when created by the robot programmer if the robot programmer actively enables this when creating the at least one operation parameter in the robot control program.

This is advantageous in that is makes programming and the presentation of configurable parts in the operator view easier and faster.

In an exemplary embodiment of the invention, the robot control program is a third-party control program which is downloaded to a data storage associated with the robot controller, wherein the third-party control program automatically updates available operation parameters in the operator window.

In an exemplary embodiment of the invention, the third-party software is integrated in the robot control program.

This is advantageous in that it has the effect that independent of type of software or source of software, the operator still has the same opportunities with respect to configuration of operation parameters and thereby flexibility in use of the robot.

A third-party control program should be understood as part of the final robot control program that is not developed by the developer of the robot manufacture or by the robot programmer (also referred to as integrator) integrating the robot on site such as in a robot cell. Hence, a third-party control program could be a control program associated with a robot tool connected to the robot enabling the robot controller to control both the robot and the robot tool. Hence, the third-party software may in total but most often in part control the robot. The latter if the third-party software is merged with additional program sequences controlling the robot. Thus, the robot control program may incorporate or make use of third-party software in the control of the robot arm. As an example, the movement of the robot arm may be controlled by the robot control program whereas the function of the tool connected to the robot arm may be controlled by the third-party software.

In an exemplary embodiment of the invention, the third party software is an application software allowing additional features to be displayed on the user interface.

In an exemplary embodiment of the invention, the additional feature is a video stream from a vision camera monitoring objects handled by a robot tool.

This is advantageous in that by such additional feature it is possible for the operator to monitor the operation of the robot from angles which not otherwise are possible. Note that the additional feature may also be an external screen displaying information related to the robot operation such as status of operation parameters.

As a general rule, the developer of the third-party software enables an operation parameter to be available in the operator view. Preferably third-party software is designed to automatically update the list of operation parameters available in the operator view.

In an exemplary embodiment of the invention, the operator view or the configuration view enables the operator to select a selection parameter, wherein the selection parameter further enables the operator to select and change an argument of at least one operation parameter.

Accordingly, the selection parameters and associated operation parameters may be understood as a menu-tree where selection of a selection parameter displays the operation parameters of that particular selection parameter. As an example could be mentioned that the selection parameter may be infeed and operation parameters may be geometry related information relating to the object being feed in. Another example could be tool, where operation parameters could be specifying the force with which a griper may apply to an object, speed of moving the object a certain distance from the robot base axis, etc.

In an exemplary embodiment of the invention, the selection parameter and associated operation parameters possible to adjust by an operator is defined by application software.

Application software may be understood as third-party software with respect to the robot program. Thus, application software may define how a particular accessory to the robot should operate/be controlled. Examples of such third-party software with respect to a robot arm from Universal Robots may be found on the Universal Robots URCap platform.

The user method of any of the paragraphs [0049] to [0096] implemented in a user interface/robot control system of the paragraphs [0005] to [0047].

### THE DRAWINGS

For a more complete understanding of this disclosure, reference is now made to the following brief description, taken in connection with the accompanying drawings and detailed description, wherein like reference numerals represent like parts. The drawings illustrate embodiments of the invention and elements of different drawings can be combined within the scope of the invention:

FIG. 1 illustrates an exemplary robot,

FIG. 2 illustrates an exemplary program view of a user interface,

FIG. 3 illustrates an exemplary operator view of a user interface,

FIG. 4 illustrates an exemplary configuration view of a user interface, and

FIG. 5 illustrates an exemplary flow chart of steps of the method of the present invention.

### DETAILED DESCRIPTION

The present invention is described in view of exemplary embodiments only intended to illustrate the principles and implementation of the present invention. The skilled person will be able to provide several embodiments within the scope of the claims.

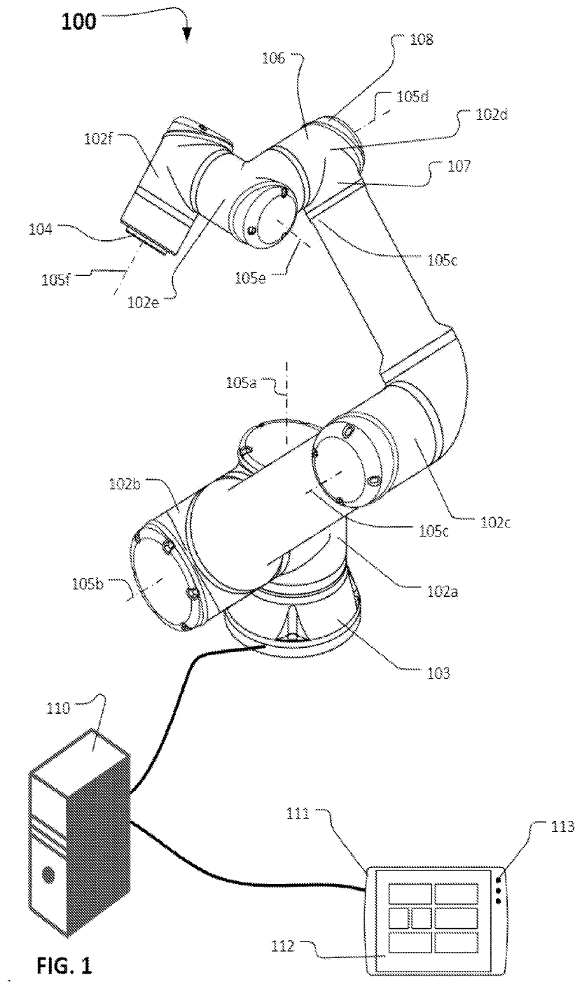

FIG. 1 illustrates a robot system 100 into which the present invention can be implemented. The robot system comprises at least one robot arm 101 and at least one robot controller 110 configured to control the robot arm.

The robot arm 101 comprises a plurality of robot joints 102a, 102b, 102c, 102d, 102e, 102f connecting a robot base 103 and a robot tool flange 104. A base joint 102a is configured to rotate the robot arm around a base axis 105a (illustrated by a dashed dotted line); a shoulder joint 102b is configured to rotate the robot arm around a shoulder axis 105b (illustrated by a dashed dotted line); an elbow joint 102c is configured to rotate the robot arm around an elbow axis 105c (illustrated by a dashed dotted line); a first wrist joint 102d is configured to rotate the robot arm around a first wrist axis 105d ((illustrated by a dashed dotted line) and a second wrist joint 102e is configured to rotate the robot arm around a second wrist axis 105e (illustrated by a dashed dotted line). Robot joint 102f is a robot tool joint comprising the robot tool flange 104, which is rotatable around a tool axis 105f (illustrated by a dashed dotted line). The wrist joint 102d is illustrated to comprise a first joint part 106, a second joint part 107 and a joint cap 108. The illustrated robot arm is thus a six-axis robot arm with six degrees of freedom with six rotational robot joints, however it is noticed that the present invention can be utilized in robot arms comprising less or more robot joints.

The robot joints comprise a robot joint housing and an output flange rotatable or translatable in relation to the robot joint housing and the output flange is connected to a neighbor robot joint either directly or via an arm section as known in the art. The robot joint comprises a joint motor configured to rotate or translate the output flange in relation to the robot joint housing, for instance via a gearing or directly connected to the motor shaft. The robot joint housing can for instance be formed as a joint housing and the joint motor can be arranged inside the joint housing and the output flange can extend out of the joint housing. Additionally, the robot joints can comprise at least one joint sensor providing a sensor signal for instance indicative of at least one of the following parameters: an angular and/or linear position of the output flange, an angular and/or linear position of the motor shaft of the joint motor, a motor current of the joint motor or an external force and/or torque trying to rotate the output flange or motor shaft. For instance, the angular position of the output flange can be indicated by an output encoder such as optical encoders, magnetic encoders which can indicate the angular position of the output flange in relation to the robot joint. Similarly, the angular position of the joint motor shaft can be provided by an input encoder such as optical encoders, magnetic encoders which can indicate the angular position of the motor shaft in relation to the robot joint. It is noted that both output encoders indicating the angular position of the output flange and input encoders indicating the angular position of the motor shaft can be provided, which in embodiments where a gearing have been provided makes it possible to determine a relationship between the input and output side of the gearing.

The robot system comprises at least one robot controller 110 configured to control the robot arm 101. The robot controller is configured to control the motions of the parts of the robot arm and the robot joints for instance by controlling the motor torque provided to the joint motors based on a dynamic model of the robot arm, the direction of gravity acting and the joint sensor signal. Further the robot controller may control the motions of the robot arm based on a robot program stored in a memory of the robot controller. The controller can be provided as an external device as illustrated in FIG. 1 or as a device integrated into the robot arm or as a combination thereof.

The robot controller can comprise an interface device 111 enabling a user to control and program the robot arm. The interface device can for instance be provided as a teach pendent as known from the field of industrial robots which can communicate with the controller via wired or wireless communication protocols. The interface device can for instanced comprise a display 112 and a number of input devices 113 such as buttons, sliders, touchpads, joysticks, track balls, gesture recognition devices, keyboards, microphones etc. The display may be provided as a touch screen acting both as display and input device. The interface device can also be provided as an external device configured to communicate with the robot controller, for instance in form of smart phones, tablets, PCs, laptops etc.

The robot system may also comprise an end effector (not illustrated) attached to the robot tool flange and it is to be understood that the end effector can be any kind of end effector such as grippers, vacuum grippers, magnetic grippers, screwing machines, welding equipment, gluing equipment, dispensing systems, painting equipment, visual systems, cameras etc.

The illustrated robot arm illustrates one example of a robot arm, however it is to be understood that the present invention can be implemented in robot arms of various types and having various kinematic structures.

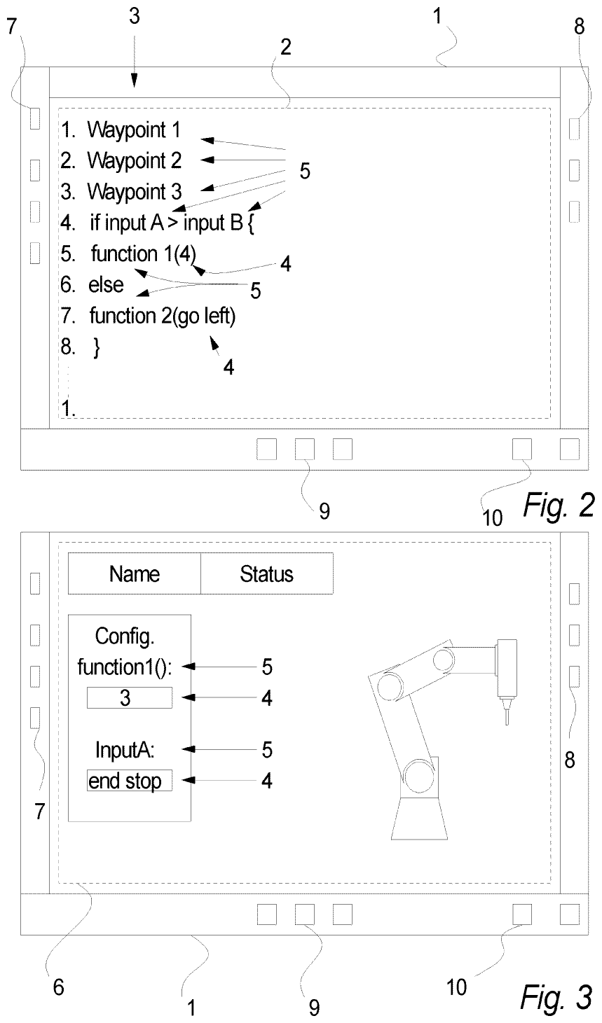

As described above in the summary of the invention, the user interface 111 is able to present various views to a user and FIGS. 2-4 illustrate various view of the user interface 1. These views include at least a status view, a configuration view, a program view and an operator view. The user is able to change between view by activating view selection buttons 7 (e.g. via touch display).

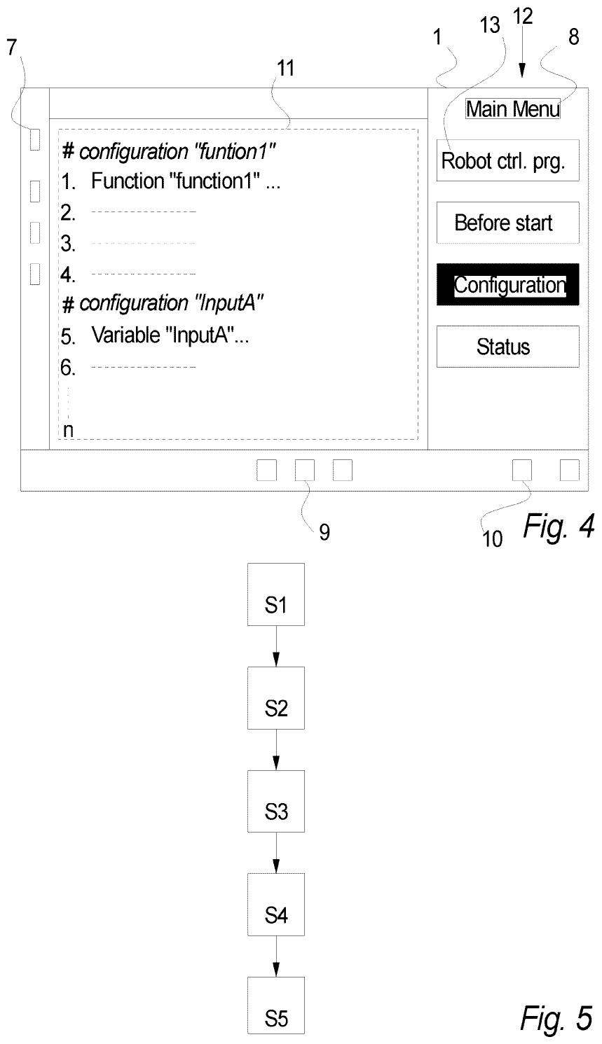

Further, the user is able to use menu buttons 8 to select information to be displayed on the display of the user interface 1. One of the menu buttons 8 may e.g. enable displaying the a menu of the configuration view (see FIG. 4 below). Another menu button 8 may e.g. enable displaying all available operation parameters of the configuration view or of the robot program.

Further, the play buttons 9 at the bottom of the user interface 1 may be used to play, pause or stop the execution of the robot program and thus the operation of the robot.

Further, the speed of the operation of the robot may be changed by the speed buttons 10 at the lower right corner of the user interface 1.

Note, that the above-described buttons and functions thereof are not limited to the illustrated positions of FIG. 2 and FIG. 3 and not limited to the above exemplary description their function.

Access is restricted to some of the views such as the configuration view and a write access to the program view. A read access to the program view may be allowed to any user of the robot. Other views such as the status view and the operator view may be accessible by all users of the robot or at least the majority of users. Hence, to access any of the view, logon to the robot controller may be required.

The interface may be referred to as a dynamic interface in that the views may be changed depending on the user using them to program or operate the robot. The dynamic should be understood as e.g. the programming view is the same as is e.g. also the integrator view and operator view. Hence, the dynamic is that different views of the interface is displayed to different users depending on if they are programmers, integrators or operators. To each of these views, is different possibilities such as programming a function/an operation parameter (first level), deciding ranges for attributes (values) of such function (second level) and teaching actual value of an attribute (third level).

As indicated, the views of the dynamic interface via which the robot control program can be accessed could be said to be structured in levels or layers according to restrictions of access. A first level view could be referred to at an OEM programmer level/view. At such first level view only expert program developers such as OEM developers may have access. Change in robot program accessible via such first level may result in changed basic operations of the robot arm and may therefore sometimes lead to a requirement of recertification of the robot control program. Accordingly, once the robot arm has left the OEM robot control program accessible via the first level view should not be changed unless maybe a tested fleet or model update from the OEM is provided.

Accordingly, via the first level view, the programmer of the robot control program may specify available content of one or more second and third level views which are available to be used by the integrator. Alternative or in addition, these views can be selected as is or modified by an integrator before allowing them to be displayed to the operator of the robot in the third level view. The views may have a built-in security feature that tests if input provided via a view e.g. from an operator is within a predefined range defined. Such function or tests may be provided by an integrator or the robot programmer.

A second level view could be referred to as an integrator level/view or configuration view or program view. At such second level the robot control program is created for a specific robot cell based basic operation. As the robot control program is created or after it is created, e.g. by an integrator, robot program elements such as functions, attributes, operation parameters, etc. that are allowed to be used/changed by an operator via a third level view is defined. As mentioned, input from the third level view may be tested and rejected or not allowed if it deviates from a predefined value(s) or is outside a predefined range.

A third level view could be referred to as an operator level/view. Via this view an operator of the robot arm is able to access the parts of the robot control program that by the integrator, e.g. via the second level view, is defined as accessible via the operator view. Hence, depending on what was decided via the second level view, the operator is able to call or move functions in the program, change or omit sequences, change valves of operation parameters, limits and thresholds, etc.

The third level view/operator view is typically only accessible prior to the operation of the robot arm, i.e. typically not accessible during operation of the robot arm. This is because the robot control program/robot cycle may at least partly be defined via the operator view. It should be mentioned that a test operation mode of the robot arm may exist during which the operator view may be accessible. In this way it is possible for the operator to step by step follow the robot cycle and change where needed.

Further, the third level view/operator view is actively activated by the operator it may not automatically popup as the dialog boxes prompting an operator for input.

Not all views are available all the time, hence e.g. the configuration view and the operator view may only be available when the robot is not in operation mode. Whereas the status view may only be available with the robot is in operation mode. A read access to the program view may be available when the robot is in operation mode and a read/write access to the program view may be available when the robot is not in operation mode.

The restrictions may be enforced e.g. by password protection or dependent on rights associated with a used logged in to the control system of the robot. It is to be understood that any kind of access control mechanism may be used to limit access to parts of the control system, such as access codes, biometric based access systems, etc.

The user interface is typically not in itself controlling the robot. Typically, the user interface is communicating with a robot controller which comprises a processor controlling the robot according to the robot control program. Thus, the user interface may be a device for monitoring and configuring the robot operation cycle.

FIG. 2 illustrates an example of a program view 2 presented via a display of a user interface 1 according to an embodiment of the invention. A robot control sequence 3 (also simply referred to as program or program tree) of a robot control program comprising three waypoints and an if/else loop is illustrated. This exemplary program comprises seven operation parameters 5 namely the three waypoints, input A and B and function 1 and 2. Each of these operation parameters 5 comprises a value also referred to as an argument 4. The argument of the waypoints and input A and B are not illustrated hence the operation parameter names are associated with an argument which is stored in the associated data storage. The arguments of function 1 and 2 however, is illustrated as the numeric number “4” and the reference “go left”.

Accordingly, operation parameters in the context of the present invention should be understood as waypoints, variables (defined e.g. by name of the variable) or functions (defined e.g. be name of the function). Non-limiting examples of operational parameters can be payload information (mass, centre of gravity, dimensions of a payload carried by the robot arm), speed and acceleration of robot movements, function call of predefined robot code, variables relating to states of peripheral equipment, test conditions, Boolean variables etc. It should be mentioned that the waypoints in some embodiments are not considered operation parameters.

As mentioned, the operator is only allowed to make changed to the robot control program in predefined areas of the robot control program. In this way, safety is maintained no matter the type of changes the operator is making. As an example, it is not possible for the operator to update the value of an argument with a value which is outside a predefined range. The range may in an embodiment be dynamic i.e. derived from other values of other arguments or limits of the robot control program. As an example, acceleration, distance from payload to robot base axis 105a and weight of payload may be interrelated. Hence, with a small acceleration and a short distance to robot base axis 105a payload weight may be higher than if the acceleration and/or distance to robot base axis 105a is high. Thus, in this example the allowable ranges for distance and/or acceleration may be adjusted based on weight of the payload. The payload weight may be provided by the operator or provided via scanning QR cods og by weighing the payload while carried by the robot or by a weight of a peripheral device communicating with the robot controller.

Both static and dynamic limits or ranges may in an embodiment be defined by a robot control program developer. Such developer may define various ranges and limits from which an integrator may choose some that are relevant for the operator to be able to access. The developer may define user interfaces from which the integrator may select some that should be visible to/accessible for the operator.

The fact that it is the developer, typically a developer of the robot arm manufacture, that is defining what is possible to change on site ensure that all requirements to safety and robot design limits are fulfilled. Accordingly, the present invention provides a safe and flexible way to configure a robot control program on site. Further, the operator does not need to have any education in safety or programming to be able to configure the robot control program.

FIG. 3 illustrates an example of an operator view 6 presented via a display of the user interface 1 according to an embodiment of the invention. The programmer who has developed the program 3 illustrated in FIG. 2 has enabled two of the seven operation parameters 5 to be displayed in the operator view 6. The two operation parameters 5 illustrated are the “function 1( )” and “input A”. The illustrated boxes in line with the operation parameters 5 represents the arguments 4 of the two operation parameters 5.

If a waypoint was considered an operation parameter, the coordinates of e.g. waypoint could be (X, Y, Z)-coordinates indicating the position of the tool flange in relation to the base of the robot. These coordinates would in this example be the argument of the waypoint and may be changed by the operator simply by typing in new coordinates such as (X1, Y1, Z1). As mentioned above, the programmer may have restricted the possible input provided by the operator, so that e.g. the Z coordinate cannot be changed and the X and/or Y coordinate can only be changed between an upper and/or lower limit. Therefore, the X coordinate may e.g. only be changed to a value in the range of X to X10. In it noted the waypoints can be indicated in many different ways such as, the position of any part of the robot arm in relation to a reference point, as joint positions indicating the angle of the robot joints. Further it is possible to allow the robot operator to define waypoints by manually changing postures of the robot arm to a desired waypoint, for instance by utilizing free drive (zero gravity) mode of the robot arm. In that connection the programmer can also restrict the allowed poses that the operator to which the operator can guide the robot arm.

The argument of function 1( ) is “3”. Hence, in the program 3 when function 1( ) is used, its argument is 3, this integer may be a reference to the actual value 3, to another function that is named “3” or the like.

The argument of input A is “end stop”. Hence, the value of input A in the if/else loop of the program is “end stop”. “end stop” may refer to an input signal and thus the input A operator parameter may change status as the end stop sensor e.g. of a conveyer change status.

Common for the arguments “X, Y, Z”, “3” and “end stop” is that they can be changed in the operator view. Either the operator can type in an integer directly or when touching the box or screen a drop-down menu is shown from which the operator can select allowable arguments for the particular operation parameter.

As mentioned, the arguments available also includes strings and Boolean operators. Hence a restriction of a string could e.g. be any given letter or combination of letters, first letter in the string, etc.

If the argument is an integer, the allowable input may as mentioned be determined by a range or upper limit, but also specific selected integers such as 5, 17 and 26. Further, input may be restricted to either an integer or a decimal number.

As mentioned, the operator view may display selection parameters. Alternative, the selection parameter is selectable from the configuration view such as from the main menu. No matter how and in which view the different selection parameters are accessed, the available operations, tasks, program parts, etc. is displayed to the user. An example of a selection parameter may be the tool (operation hereof) such as a gripper, suction disc, welder, polisher, wrapper, etc. Selecting e.g. a polisher, operation parameters such as the force the robot is applying to the object via the polishing tool, speed for movement of the robot when polishing the object or different parts of the object, way point for the trajectory, time for polishing the same spot of the object, etc. can be made available for adjustment by the operator. The same and/or similar and/or other relevant operation parameters of a given tool may be made available for adjustment upon selecting the “tool” selection parameter.

The selection parameters may be defined by the robot programmer, integrator or even via application software from a third party. Application software may e.g. be a piece of software which is developed by a third-party supplier of a tool. Hence, e.g. in a program node where the tool is to be operated, the software controlling such operation of the tool may be referred to as application software.

When installed, such tool application software may include selection parameters which comprise one or more operation parameters related to the tool which by the tool developer is considered relevant for the operator to be able to adjust. As other control parameters, there may be limits for the values of the operation parameters the operator is allowed to input, such limits are typically defined by the developer of the tool application software or the integrator.

Of course, it should be understood that the example described with reference to FIG. 2 and FIG. 3 is a very simple illustration of the present invention and thus more complex programs 3 and more operation parameters 5 would typically be used and benefit from the present invention. Also, the exemplary arguments are only for illustrating the principles of the invention.

It should be mentioned that in the operator view, a robot as the one controlled by the robot control code may be illustrated to demonstrate the effect on the configured operation parameter in a graphical view.

FIG. 4 illustrates an example of a configuration view 11 presented via a display of the user interface 1 according to an embodiment of the invention. In this illustration the main menu 12 is expanded e.g. by a user pushing one of the menu button 8 (illustrated in FIG. 2 and FIG. 3). Thus, options of the configuration view 11 according to this embodiment is illustrated. The main menu 12 may be collapsed again e.g. by pushing the “Main Menu” button 8 or one of the view selection buttons 7 The main menu 12 comprises a number of menu options, where one menu option 13 is to view the entire robot control program, which may open the program view of the user interface illustrated on FIG. 2. Alternatively, the robot control program may open in the configuration view 11 e.g. with the menu option of the expanded main menu 12 available as illustrated on FIG. 4.

Another menu option is the “before start” which is a program that is executed only once prior to running the main program. The software code configured under the before start option may configure various routines, initiate different parameters and in/output, etc. The configurations made under this “before start” menu option is only run once before each time the robot control program is started. This is in contrary to the main robot control program which typically is looping thus repeating one operation cycle of the robot.

Another menu option is the status of the operation parameters. The status option enables the operator to set up counters, timers, etc. for being able to count number of items handled, number of cycles conducted, time for conducting one cycle, etc. Hence, the status option could be the to read or provide information from or about the robot control program to the operator contrary to the configuration of operation parameters described above that could be the to provide information from the operator to the robot control program.

The status tasks may be used to count items placed on a pallet, to monitor when the next layer is to begin or the pallet is full and should be replaced, the value of an operation parameter, etc.

Another menu operation is the configuration of operation parameter that has been describe in relation to FIG. 2 and FIG. 3 above. The configuration view 11 illustrated on FIG. 4 is where the experienced programmer is able to determine what the operator is allows to see and change in the operator view 6. Referring to the operator view illustrated on FIG. 3 where function1 and inputA is configurable, these operation parameters and if relevant also the range in which they can be change is defined in the configuration view 11 illustrated in FIG. 4. The programmer in this example has used code lines 1-4 to configure what can be seen in the operator view 6 relating to the function 1 operation parameter and code lines 5 and 6 to configure what can be seen in the operator view 6 relating to the inputA operation parameter.

In the operator view 6 of FIG. 3, the status view and the configurable operation parameters is illustrated side by side. It is noted, that in this example no status of operation parameter is illustrated.

An operator can thus via the operational view change /odify the operation of the robot, as selection, change, or modification of one of the operational parameters changes the operation of the robot. As an example, the robot may be moving or it may be mounted on wheeled structure and moved from one machine to another e.g. to supply objects to the machine from a conveyer which would require a change of operation. Another example that would require a change in operation may be changing object to be welded. The robot may also be stationary where it handles different packing and/or picking operations. The operator may between such shift in operation of the robot simply change the function call (operation parameter) to change operation of the robot arm from picking up objects provided in one geometry to picking up objects provided in another geometry, just to mention a low practical example.

In addition to the new sequence of picking up objects, the objects may also change geometry and thus the operator may change value of waypoint, offset, etc. to match the new operation environment. This may include change infeed of objects from one square like geometry with 5×8 objects of a first size to another with 3×5 layout of larger objects. Further, if two different objects are to be welded with a known welding path, the operator may change operation of the robot from one operation to the other only by changing the operation parameter to another function call and defining predetermined waypoints. Such teaching of the robot may be done by the operator which do not have any robot programming experience either by manual input or by moving the robot in free-drive.

It should be noted that even though only the stipulate boxes of FIG. 2-FIG. 4 are referred to as program, operator and configuration view 2, 6, 11 the entire user interface may be referred to as program, operator and configuration view 2, 6, 11 respectively.

Note that the present invention also facilitates to provide arguments to external devices such as a screen or controller. Further, arguments may also provide information to third party software. Hence if such third party software when downloaded and integrated in the robot control program need an argument for an operation parameter, then this argument may automatically be provided to the third party software or retrieved from the robot control program or data storage.

FIG. 5 illustrates a simple flow chart of the steps of the configuration method of the present invention. In the first step S1, the robot control program is established i.e. written in, loaded (from a memory storage such as local memory or cloud based memory storages) into the robot control software or a combination there of. The robot control program is presented in a program view of the display of a user interface.

In the second step S2, during or after the creation of the robot control program, the experienced robot programmer, select various operation parameter and makes these available from an operator view.

In the third step S3, prior to operation of the robot is initiated, a non-experienced robot programmer such as a robot operator is able to access these operation parameters from the operator view. Via the operator view other interaction or monitoring of the robot control program can be established as described above.

In the fourth step S4, the operator is allowed to give values (arguments such as integers, strings, Boolean and functions) to operation parameters, which impacts the operation of the robot. Thus, after the operator has configured the operation parameters the subsequent operation cycle may be referred to as a modified operation cycle.

In the fifth step S5, the robot control program is executed and the modified operation cycle will be performed and if any monitoring was established in step S3, this can be followed from the operator view. Further the status of the operator selected parts of the operation values made available by the robot programmer can also be followed from the operator view.

From the above it is now clear that the invention concerns two main parts namely first the robot control program which when or after being programmed enables a configuration of operation parameters that an operator is able to modify. The modification is performed in an operator view of a user interface. Second, the operator view is part of the user interface to the robot specifically developed for non-specialized robot operators which through the operator view still is able to, among other things, configure operation parameters of the robot control program and thus modify the robot cell behavior.

From inside the program view or configuration view an experience robot programmer such as a robot integrator can set up various operation parameters which as mentioned will be available to easily configure to adapt the program to various conditions via the operator view. The operator view via which the operator, or non-robot programmer, performs or interacts with this configuration. Here the operator can, through a simplified interface, change various parameters of the robot program execution to adapt the program to various situations.

The above-described method and user interface is especially advantageous in small and medium enterprises where no experienced robot programmer is available each time e.g. a size of an object handled by the robot is changing.

The invention has been exemplified above with the purpose of illustration rather than limitation with reference to specific examples of methods and robot systems. Details such as a specific method and system structures have been provided in order to understand embodiments of the invention. Note that detailed descriptions of well-known systems, devices, circuits, and methods have been omitted so as to not obscure the description of the invention with unnecessary details.

### LIST

1. Robot user interface
2. Program view
3. Robot control sequence
4. Arguments
5. Operation parameters
6. Operator view
7. View selection buttons
8. Menu buttons
9. Play buttons
10. Speed buttons
11. Configuration view
12. Main menu
13. Menu option
100. Robot arm
102a-102f. robot joint
103. robot base
104. robot tool flange
105a-105f. axis of robot joints
106. first part of robot joint
107. second part of robot joint
108. robot joint cap
110. robot controller
111. interface device
112. display
113. input devices
S1. establishing robot control program
S2. selecting operation parameters
S3. accessing operation parameters
S4. give values to operation parameters
S5. Execute robot program

1. A user interface for controlling a robot, the user interface comprising:
a program view configured to display at least part of a control program for controlling the robot the control program comprising operation parameters for controlling operations of the robot based on arguments associated with the operation parameters; and
an operator view configured to display one or more of the operation parameters, the operator view also being configured to display one or more arguments associated with respective ones of the one or more operation parameters, the operator view being configured to allow changes to the one or more arguments more.

2. The user interface of claim 1, further comprising:
a configuration view to change content to be displayed in the operator view.

3. The user interface of claim 2, wherein the configuration view is configured to enable changing the one or more arguments to be displayed in the operator view.

4. The user interface of claim 2, wherein the configuration view is configured to enable selection of the one or more operation parameters to be displayed in the operator view.

5. The user interface of claim 2, wherein the program view is configured to enable display of the configuration view.

6. The user interface of claim wherein the configuration view enables selection of the one or more operation parameters.

7. The user interface of claim 2, wherein the user interface comprises a display to enable selection of at least one of the said program view, the configuration view, or the operator view.

8. The user interface of claim 1, further comprising:
a status view configured to display a status of one or more operation parameters while the control program executes

9. The user interface of claim 1, wherein the operator view is configured to display at least one selection parameter, the at least one selection parameter for causing display of one or more operation parameters relating to objects associated with the robot; and
wherein the operator view is configured to allow setting of the at least one selection parameter and to display the one or more view arguments based on the at least one selection parameter.

10. The user interface of claim 1, wherein the content displayed in the operator view is configurable.

11. The user interface of claim 1, wherein the operator view is configured for display to said a user prior to operation of the robot.

12. The user interface of claim 1, wherein both the program view and the operator view are configured to enable configuration of the one or more operation parameters.

13. The user interface of claim 1, wherein access to the program view is restricted.

14. (canceled)

15. A method of configuring a control program for a robot, the method comprising
receiving the control program, wherein the control program is configured to control of said the robot according to an operation cycle, and wherein control of the robot according to the operation cycle is based on a of operation parameters;
displaying least part of the control program in a program view of a user interface;
receiving, at the user interface, a selection of one or more of the operation parameters;
displaying the one or more operation parameters that were selected in an operator view of said the user interface; and
configuring the control program by changing, in the operator view, an argument of at least one of the operation parameters wherein changing the argument configures the control program to control of the robot according to a modified operation cycle.

16. The method of claim 15, wherein the one or more operation parameters in are selected from a configuration view of the user interface, the configuration view to change content to be displayed in the operator view.

17. The method according to claim 16 further comprising:
configuring, in the configuration view, limits of one or more arguments of the one or more operation parameters.

18. The method of claim 16, wherein the configuration view. enables the one or more operation parameters to be defined.

19. The method of claim 16, wherein said the configuration view is accessible from the program view.

20. The method of claim 15, further comprising:
configuring a routine that is executed once before execution the robot control program.

21. The method of claim 15, further comprising:
configuring a status task that provides information from control program.

22. The method of claim 15, wherein at least one of the operation parameters is comprises a function call.

23. The method of claim 15, wherein the argument is changed within a predetermined range.

24. The method of claim 15, wherein the argument is associated with a robot tool or peripheral device.

25. The method of claim 15, wherein the one or more operation parameters are selected prior to commissioning the robot.

26. The method of claim 15, wherein the one or more operation parameters are automatically displayed in the operator view when automatic display is enabled.

27. The method of claim 15, wherein the control program is comprises a third-party control program that is downloaded to a data storage device associated with a robot controller that performs at least part of the method, wherein the third-party control program automatically updates operation parameters in the operator view.

28. The method of claim 27 wherein the third-party control program is integrated into the control program.

29. The method of claim 27 wherein the third party control program comprises application software configured to display one or more features in the user interface.

30. The method of claim 29, wherein the one or more features comprise a video stream from a vision camera that monitors an object handled by a tool of the robot.

31. The method of claim 16, wherein the operator view or the configuration view enables selection of a selection parameter, and wherein the selection parameter enables changing the argument.

32. The method of claim 31, wherein the selection parameter and an associated operation parameter an are defined by application software.

33. The user interface of claim 1, wherein the user interface comprises a hardware display device.
